(19) United States
(12) Patent Application Publication
(10) Pub. No.: US 2008/0108306 A1
(43) Pub. Date: May 8, 2008

(54) ADAPTABLE HEADSET

(75) Inventor: Dawson Yee, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/556,645

(22) Filed: Nov. 3, 2006

(51) Int. Cl. H04B 7/00; H04R 25/00

(52) U.S. Cl. 455/41.2; 370/310; 381/375; 381/370; 379/441

(57) ABSTRACT

Communications systems that include an adaptable headset are described. In various embodiments, the communications system comprises a handheld device and a headset device that can be removably coupled to the handheld device. The headset device can comprise a replenishable power source that recharges via electrical power when the headset device is removably coupled to the handheld device.

### BACKGROUND

People use communications devices, such as telephones, cellular telephones, Voice over Internet Protocol (VoIP) telephones, facsimile machines, and other communications devices to communicate with others. These devices generally have a handset such as a corded handset. The corded handset generally has a speaker for converting electrical signals to sounds, and a microphone for converting sounds to electrical signals. The electrical signals transit various switches and other devices to enable the communications. The electrical signals may also be converted to digital signals when transiting data and voice networking devices. The handsets can also be wireless.

These communications devices can sometimes be employed with external devices instead of, or in addition to, the corded handset. As an example, the communications devices can be employed with a speaker and/or microphone that is separate from the corded handset, such as in a “speakerphone” configuration. In this configuration, the user does not have to hold a corded handset to the user's ear and mouth. Conversely, the user merely has to speak or listen within some range of the communications device. The speakerphone functionality can sometimes be built into a handset, such as a wireless handset. As another example, the communications devices can be employed with a headset device. The headset device is similar to a handset in that it is located proximate to at least the user's ear. The headset can be connected to the communications device or handset via a wire or wirelessly. In general, wired headsets generally need no separate power source, whereas wireless headsets need a power source. Wireless handsets and headsets both can communicate with a communications device (e.g., a base station) using various wireless communications technology, such as spread spectrum, IEEE 802.11, “Bluetooth,” conventional radio signals, and so forth.

An advantage to using handsets is that the conversation can be relatively private. As an example, the user can hear another party via the speaker without others who are nearby being able to hear the conversation. However, when the user needs to juggle multiple tasks requiring both hands, holding the handset can be difficult. The user may then switch to a speakerphone configuration. However, in this configuration, others who are nearby may be able to hear both sides of the conversation and may find it bothersome. Headsets offer the advantage of privacy as well as the ability to use both hands. As a result, wireless headsets, such as for use with cellular and conventional telephones, have become popular both in the home as well as in the office. However, wireless headsets, such as of the Bluetooth variety, need to be recharged. Moreover, they sometimes get lost because they are awkward and are disconnected from the handset, which may be the primary communications apparatus.

### SUMMARY

Communications devices and adaptable headsets are described. In various embodiments, a communications device is a “base station,” such as a telephone, handset, facsimile machine, and so forth. The base station enables communications with other communications devices, such as via a telephone network or a data network. The base station can communicate with other communications devices wirelessly or via a wired communications network. The adaptable headset can receive signals from the base station via a wired or wireless connection. In various embodiments, when the adaptable headset is configured for wired use, it may provide a speaker or microphone in addition to, or in lieu of, a speaker or microphone ordinarily employed by the base station. In these embodiments, the adaptable headset may replenish its power source (e.g., rechargeable battery) if a replenishable power source is available. Whether the adaptable headset is configured for wired or wireless use, it can receive signals from the base station, emit corresponding audio signals, receive sounds, provide corresponding signals to the base station, and so forth. When the adaptable headset is configured for wireless use, it may consume power from its replenishable power source.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an isometric view depicting an arrangement of a communications device in accordance with an embodiment.

FIG. 2 is an enlarged isometric view depicting an arrangement of a wireless headset in accordance with an embodiment.

FIGS. 3 and 4 are isometric views depicting arrangements of communications devices in accordance with some embodiments.

FIG. 5 is a block diagram depicting a hardware arrangement of a wireless headset or a base station in accordance with an embodiment.

FIG. 6 is a flow diagram illustrating an operation of a wireless headset in accordance with an embodiment.

### DETAILED DESCRIPTION

A facility including communications devices and adaptable headsets is described. In various embodiments, the communications device is a “base station,” such as a telephone, handset, facsimile machine, and so forth. The base station enables communications with other communications devices, such as via a telephone network or data network. The base station can communicate with other communications devices wirelessly or via a wired communications network. The adaptable headset can receive signals from the base station via a wired or wireless connection. In various embodiments, when the adaptable headset is configured for wired use, it may provide a speaker or microphone in addition to, or in lieu of, a speaker or microphone ordinarily employed by the base station. As an example, a handset with which the headset is connected may not have a speaker or microphone. In these embodiments, with a wired connection the adaptable headset may replenish its power source if a replenishable power source is available. As an example, it may recharge its rechargeable battery. Whether the adaptable headset is configured for wired or wireless use, it can receive signals from the base station, emit corresponding audio signals, receive sounds such as a human's voice, provide corresponding signals to the base station, and so forth. The signal exchange with the base station can employ a physical connection or a wireless connection. Examples of wireless connections include Bluetooth, IEEE 802.11, light signals (e.g., via LED), and so forth. When the adaptable headset is configured for wireless use, it may consume power from its replenishable power source.

In various embodiments, the adaptable headset can have one or more speakers to project sounds into one or both human ears. The adaptable headset may have a housing constructed from a rigid material, such as a material made from plastic, a lightweight metal, or some combination of both. The adaptable headset can hang from a human ear, human head, or inserted into a human ear. When the adaptable headset hangs from an ear or a head, it may have an adjustable hanging portion that is affixed to the housing. The adjustable hanging portion can be adapted for various ear or head sizes. The adaptable headset's housing may also be rotatable about a joint at which the hanging portion is affixed to it, such as to adjust a microphone portion of the headset to be closer to or farther from the human's mouth. The microphone portion includes a device for capturing sounds, such as the voice of the person wearing the adaptable headset. The adaptable headset may employ rechargeable or non-rechargeable batteries, though the replenishing via the base station may function primarily with rechargeable batteries. The adaptable headset may have one or more electrical connections. One of these electrical connections may supply power to the adaptable headset when the adaptable headset is configured to employ a wired connection to the base station. The adaptable headset can employ this power to replenish its replenishable power source.

In various embodiments, the base station includes a power source. This power source can be a power connection, such as from an electrical outlet, or a portable power source, such as a battery. The base section's battery may also be replenishable, such as via replacement or recharging. When the adaptable headset is connected to the base station, such as by using a physical or wired connection, the adaptable headset's power source can be replenished, such as by charging its rechargeable battery. The adaptable headset's power source can be replenished by drawing power from the base station's power source. This can occur automatically, such as by detecting that the adaptable headset and the base station are connected, or after a user indication to replenish, such as via a switch. The facility can indicate that the adaptable headset's replenishable power source needs to be replenished, is replenishing, fully replenished, etc. As an example, the adaptable headset can display its power level using an LED. Moreover, when the adaptable headset is connected to the base station, the adaptable headset and the base station may exchange signals via a wired connection or wirelessly. These signals can provide audio or video information. As an example, the base station can communicate VoIP signals it receives in a way that the adaptable headset can play back the signals audibly. Various means are known in the art for configuring transceivers to exchange signals between base stations and other remote devices. The base station can also receive signals from the adaptable headset and translate these signals into a manner for sending on a network, such as by translating received signals into VoIP messages. The base station may use a communications component for connecting to a network and translating signals to or from VoIP messages.

In various embodiments, the handheld device can be a handset, personal digital assistant, mobile telephone, or any other handheld device.

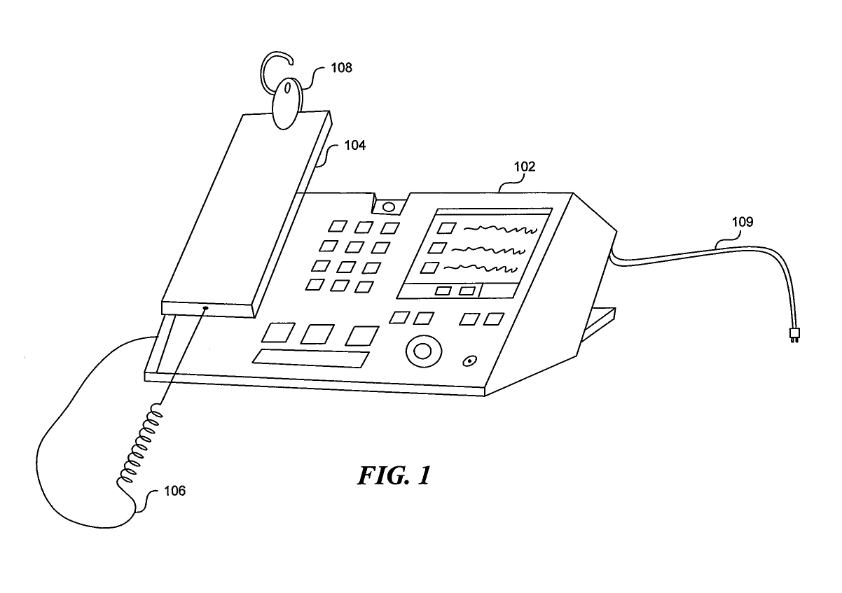

Several embodiments of the facility are described in more detail in reference to the Figures. FIG. 1, for example, is an isometric view depicting an arrangement of a communications device 102 in accordance with an embodiment. The communications device 102 comprises a handset 104 communicably coupled thereto via a wire 106 or other link. The handset 104 may have a removably couplable adaptable headset 108. In various embodiments, including the illustrated embodiment, the adaptable headset 108 may be an “earbud” type device that can hang from a user's ear (not shown), such as from an upper region of the ear's pinna portion. The adaptable headset 108 can be removably coupled to the handset 106. When connected to the handset 104, the adaptable headset 108 can provide wired services and replenish its power source, such as by recharging its battery. When removed from the handset 104, it can be used as a conventional headset. The communications device 102 can connect to a communications network or computing device (not illustrated) via a communications cable 109. Accordingly, the communications device 102 can provide telephone services, such as by using VoIP or other link, such as a wireless link (not illustrated).

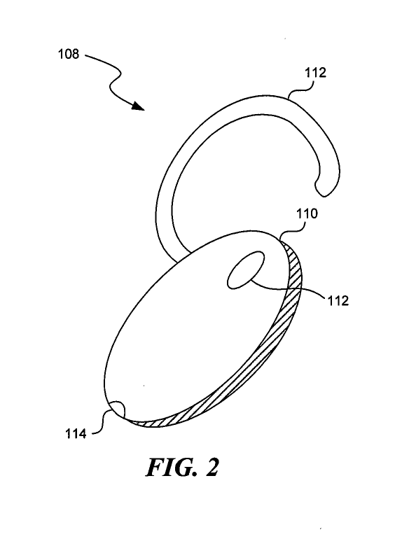

FIG. 2 is an enlarged isometric view depicting an arrangement of the adaptable headset 108 in accordance with an embodiment. The adaptable headset 108 includes a body portion 110 and an attachment portion 112. The attachment portion 112 can be employed to temporarily affix the adaptable headset 108 to a user's head (not shown), such as by hanging it from the pinna portion of the user's ear. The body portion 110 contains electronic circuitry that may be needed to handle communications with the base station (e.g., a handset 104 or a communications device 102). In the illustrated embodiment, the body portion 110 also includes a speaker aperture 112 through which sounds can be emitted and a microphone aperture 114 through which sounds can be collected.

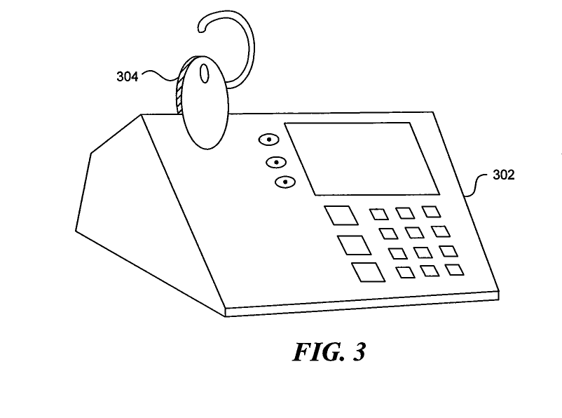

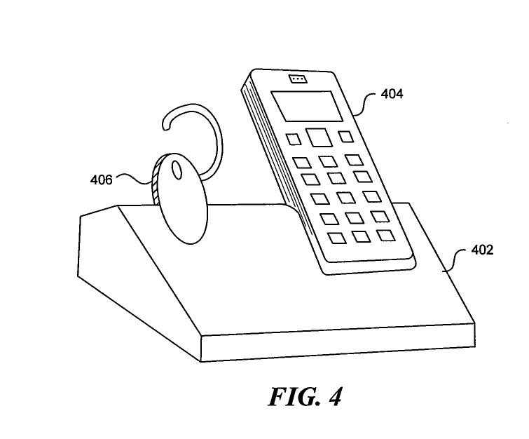

FIGS. 3 and 4 are isometric views depicting arrangements of communications devices in accordance with some embodiments. FIG. 3 illustrates a communications device 302, such as a facsimile or speakerphone having a removably couplable adaptable headset 304. The adaptable headset 304 can be at least generally similar in structure and function to the adaptable headset 108 described above in relation to FIGS. 1 or 2. FIG. 4 illustrates a communications device 402 that incorporates a removably couplable wireless handset 404 and a removably couplable adaptable headset 406. The adaptable headset 406 can be at least generally similar in structure and function to the headset 108 described above in relation to FIGS. 1 or 2. The adaptable headset 406 may be removably couplable with the wireless handset 404, though not illustrated as coupled.

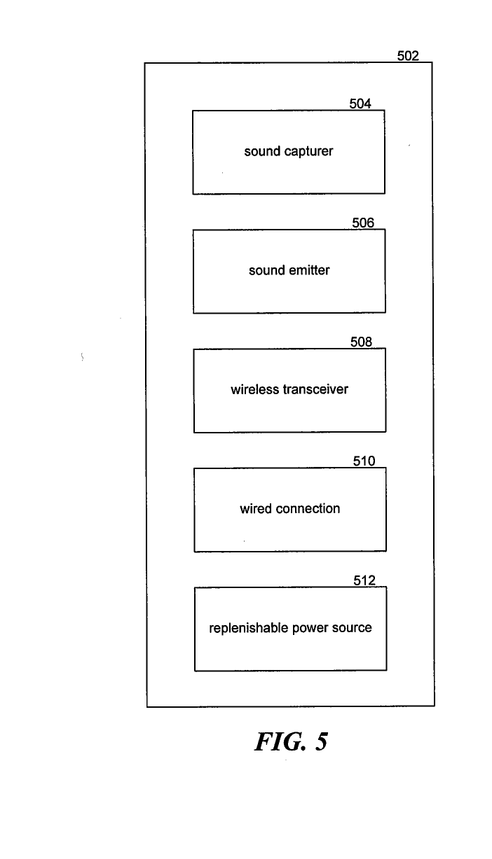

FIG. 5 is a block diagram depicting a hardware arrangement of an adaptable headset at a base station in accordance with an embodiment. In some embodiments, the hardware depicted in FIG. 5 can be generally similar in structure and function to the hardware contained in adaptable headsets 108, 304 and/or 406 described above in relation to FIGS. 1-4. The adaptable headset may include a hardware portion 502 that includes a sound capturer 504, sound emitter 506, wireless transceiver 508, wired connection 510, and replenishable power source 512. The wired connection can include connectors for transferring or receiving electrical power and for exchanging signals, such as to receive or provide audio or video signals. The adaptable headset may also contain other components. A base station (e.g., handset 104, device 302, device 402, etc.) may also contain these and other components. In various embodiments, some of these components may be removed or other components can be added.

The sound capturer 504 can capture sounds, such as via a microphone or other sound-capturing device. The sound emitter 506 can emit sounds, such as via a speaker or other sound-emitting device. The wireless transceiver 508 can communicate with the base station, such as by using Bluetooth, light signals, radio signals, etc. The wired connection 510 can be employed to exchange signals between the adaptable headset and the base station, such as when the headset is coupled to the base station. The wired connection 510 may also be employed to replenish the headset's replenishable power source 512, such as by providing electrical power to recharge a rechargeable battery. The replenishable power source 512 can be a rechargeable battery, replaceable battery, etc.

A base station may also include a communications component (not illustrated) that enables communications with a network, such as via VoIP, telephone, etc. The base station can also connect to another device (e.g., a computing device) to enable communications with the network.

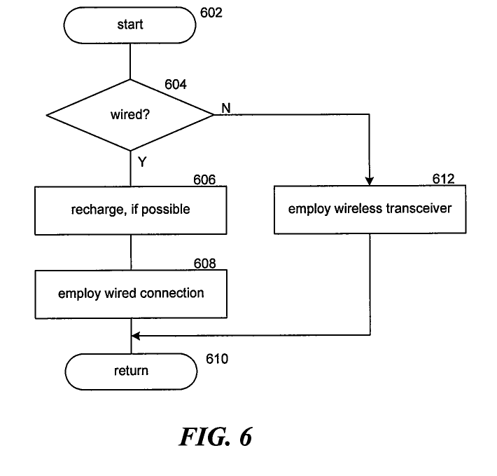

FIG. 6 is a flow diagram illustrating an operation of an adaptable headset in a wireless configuration, such as adaptable headsets 108, 304, and/or 406, in accordance with an embodiment. The illustrated routine can be performed by an adaptable headset, such as the adaptable headsets 108, 304, and/or 406 described above, at any point during a conversation in which the communications device is employed. The routine starts at block 602.

At block 604, the routine determines whether a wired connection 510 is being employed between the adaptable headset, such as adaptable headsets 108, 304, and/or 406, and a base station (e.g., handset 104, device 302, device 402, etc.) When a wired connection 510 is being employed, the routine continues at block 606. Otherwise, the routine continues at block 612.

At block 606, the routine replenishes the replenishable power source of the adaptable headset 512, if possible. As an example, if the routine detects that a rechargeable battery is installed, it attempts to recharge the battery.

At block 608, the routine may employ the wired connection 510. As an example, in some embodiments, the handset 104 and adaptable headset 108 may exchange signals via the wired connection 510. In other embodiments, the logic of this block may be ignored and the communications between the handset and adaptable headset may be via a wireless connection employing wireless transceiver 508, such as by using the logic associated with block 612. The routine then returns at block 610.

At block 612, the routine employs the wireless transceiver 508 to communicate with the base station. A base station (e.g., handset 104, device 302, device 402, etc.) may contain these and other components. In various embodiments, some of these components may be removed. The routine then returns at block 610.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I claim:

1. A modular communications system, comprising:
a base station; and
a headset device removably coupled to the base station, wherein the headset device comprises a replenishable power source that recharges via electrical power when the headset device is removably coupled to the handheld device.

2. The modular communications system of claim 1, further comprising a wired connection operably coupling the headset device to the base station.

3. The modular communications system of claim 2 wherein the headset device includes a first wireless transceiver and the base station includes a second wireless transceiver configured to exchange wireless signals with the first wireless transceiver during operation of the modular communications system.

4. The modular communications system of claim 3 wherein the wireless transceivers are configured to exchange Bluetooth signals.

5. The modular communications system of claim 3 wherein the wireless transceivers are configured to exchange light signals.

6. The modular communications system of claim 3 wherein the wireless transceivers are configured to exchange radio frequencies.

7. The modular communications system of claim 3 wherein the headset device is spaced apart from the base station.

8. The modular communications system of claim 1, further comprising a wired connection operably coupling the headset device to the base station.

9. The modular communications system of claim 8 wherein the wired connection provides electrical power to the headset device.

10. The modular communications system of claim 8 wherein the wired connection provides communications signals between the headset device and the base station.

11. The modular communications system of claim 1 wherein the replenishable power source includes a rechargeable battery.

12. The modular communications device of claim 1 wherein the headset device includes an earbud.

13. The modular communications system of claim 1 wherein the base station comprises a data communications component that enables VoIP communications.

14. A modular communications system for integrating a hands-free environment with a handheld environment, comprising:
a handheld means for enabling a handheld environment; and
a headset means for enabling a hands-free environment, wherein the headset means is removably coupled to the handheld means and comprises a replenishable power source that recharges via electrical power from the handheld means.

15. The communications system of claim 14 wherein the handheld means includes means for enabling communications via communications network.

16. The communications system of claim 14 wherein the replenishable power source includes connection means for receiving electrical power from the handheld means.

17. The communications system of claim 14 wherein the replenishable power source is a rechargeable battery.

18. A modular communications system, comprising:
a handheld device; and
a headset device removably coupled to the handheld device, wherein the headset device comprises:
a power source that recharges via electrical power when the headset device is coupled to the handheld device;
a wireless transceiver that wirelessly exchanges signals with the handheld device; and
a sound emitter component configured to emit sounds based on signals the headset device receives.

19. The modular communications system of claim 18 wherein the headset device further comprises a sound capturer component configured to capture sounds that the headset device receives.

20. The modular communications system of claim 19 wherein the sound capturer component includes a microphone.
